(19) United States
(12) Patent Application Publication
(10) Pub. No.: US 2004/0213225 A1
(43) Pub. Date: Oct. 28, 2004

(54) Re-use of channel estimation information in a wireless local area network

(75) Inventor: John T. Coffey, San Francisco, CA (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/424,474

(22) Filed: Apr. 28, 2003

(51) Int. Cl. H04L 12/28

(52) U.S. Cl. 370/389

(57) ABSTRACT

Encoded information in a data network may be decoded using a value, indicative of the communication channel, obtained from the information to be decoded as well as at least one other value, also indicative of the communication channel, obtained from previously decoded information. By using a channel indicating value obtained from previously decoded information, a better performing decoding process may be obtained.

### BACKGROUND

1. Field of the Invention

The present invention generally relates to communication systems. More particularly, the invention generally relates to wireless local area networks and more particularly still to the use of channel estimation information.

2. Background Information

Data networks typically involve data packets transmitted from one point in the network to another. It is possible that one or more bits in the packet being transmitted may be received in error. Improvements that result in information being more accurately received in a network are desirable.

### BRIEF SUMMARY

In accordance with various embodiments described herein, encoded information in a data network may be decoded using a value, indicative of the communication channel, obtained from the information to be decoded as well as at least one other value, also indicative of the communication channel, obtained from previously decoded information. Such “values” may comprise a single data item or a plurality of data items and is used to encompass all such variations in this disclosure. By using a channel indicating value obtained from previously decoded information, a better performing decoding process may be obtained.

In at least some embodiments, a device may be adapted to receive packets from another device via a communication channel. The device may comprise, among other components, a decoder coupled to the antenna. The decoder preferably receives encoded information, determines a first value indicative of the communication channel from the received encoded information, determines a second value indicative of the communication channel from previously received and decoded information, and decodes the received encoded information using whichever of the first or second values that results in better decoding performance. The device may comprise a wireless device (e.g., an IEEE 802.11 device).

The values that are obtained and that are indicative of the channel may comprise gain and/or phase values. In at least some embodiments, the decoding process comprises Viterbi decoding which used reliability metrics. In such embodiments, the channel gain may be used to multiply the Viterbi reliability metrics.

### BRIEF DESCRIPTION OF THE DRAWINGS

For a detailed description of the preferred embodiments of the invention, reference will now be made to the accompanying drawings in which:

FIG. 1 illustrates a communication system in accordance with a preferred embodiment of the invention;

FIG. 2 shows an exemplary embodiment of a data packet and use of the packet to determine a channel characterization value usable in a decode process;

FIG. 3 shows a preferred method of decoding a data packet using channel characterization values from at least two different data packets;

FIG. 4 illustrates an embodiment in which one of the channel characterization values comprises an average of the channel characterization values determined from previous data

FIG. 5 illustrates an embodiment of the communication system as comprising an access point and one or more wireless stations; and

FIG. 6 shows a preferred embodiment of an access point or a wireless station.

### NOTATION AND NOMENCLATURE

Certain terms are used throughout the following description and claims to refer to particular system components. As one skilled in the art will appreciate, different companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to.”. Also, the term “couple” or “couples” is intended to mean either a direct or indirect connection. Thus, if a first device couples to a second device, that connection may be through a direct connection, or through an indirect connection via other devices and connections. To the extent that any term is not specially defined in this specification, the intent is that the term is to be given its plain and ordinary meaning.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

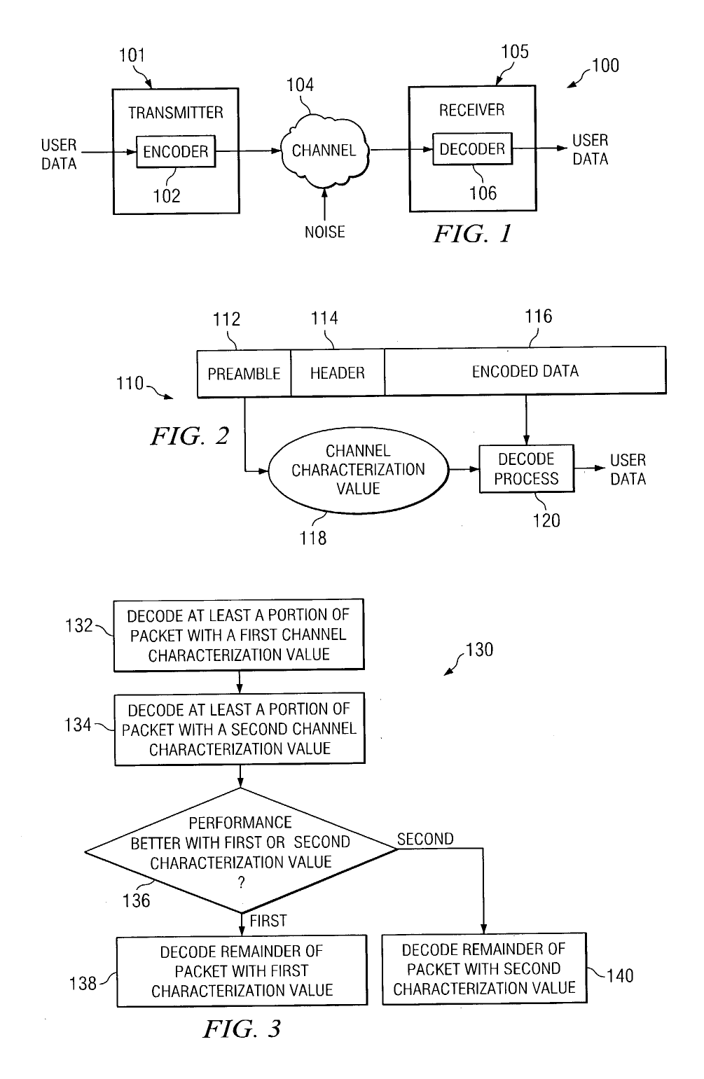

Referring now to FIG. 1, a communication system 100 may include a transmitter 101 that provides information through a communication channel 104 to a receiver 105. The communication system 100 may be wire-based, including electrical wire, fiber optics, and other forms of direct connection, or wireless-based, including RF, IR, and other forms of wireless transmission. The transmitter 101 may include an encoder 102. The encoder 102 may receive user data, encode the user data, and provide the encoded data to the decoder 106 through the channel 104. The receiver 105 may include a decoder 106. The decoder 106 receives the encoded data from the channel 104 and decodes the encoded data to obtain the originally sent user data. Additional components (e.g., modulators, demodulators, antennas, etc.) may be included in communication system 100.

Noise may be added to the encoded data as the data traverses the channel 104. The noise may take one or more of a variety of forms including interference from an external source, multipath distortion, and so on. The term “noise” is intended herein to generally include any type of distortion of the user data as it passes through the channel and as it is received at the decoder end of the communication system 100.

The encoder 102 and decoder 106 may act in concert to help circumvent in deleterious effects of the noise. Any one of numerous types of encoding and decoding schemes may be implemented in the preferred embodiment of FIG. 1. For example, the encoding scheme employed by the encoder 102 may include convolutional encoding or block coding as would be well known by those of ordinary skill in the art. Examples of suitable decoding techniques may include Viterbi decoding. Suitable encoding and decoding techniques can be found in a variety of references such as U.S. Pat. No. 6,507,927, incorporated herein by reference.

Information may be transmitted by the transmitter 101 to the receiver 105 in accordance with any one or more of a variety of formats and techniques. With regard to FIG. 2 and without limitation, one such format is shown as a data packet 110. Data packet 110 may include a preamble 112, a header 114, and a data payload 116. The preamble 112 generally may be used to alert all possible receiving devices that a data transmission is beginning. The preamble may include one or more predetermined and/or formatted bit sequences that may be used by the receiver 105 to configure itself to receive the packet correctly. The header 114 may include a variety of information such as the length of the packet, the speed of transmission of the packet, and error check bits. The data payload 116 includes the user data that the transmitter 101 is attempting to transmit to the receiver 105. Once encoded by the encoder 102, the data payload 116 includes encoded data.

Referring still to FIG. 2, in accordance with the preferred embodiments of the invention, the receiver 105 determines, measures or otherwise obtains a channel characterization value 118 from, or based on, the packet's preamble 112. This value may be obtained by the receiver's decoder 106 or other logic (not specifically shown) in the receiver 105. The “value” may comprise a single data item or a plurality of values. In some embodiments (e.g. 802.11a systems) the channel characterization value may composite the gain and phase of 48 frequency tones. The channel characterization value generally characterizes the communication channel 104. The ability of the channel 104 to transfer the packet from the transmitter 101 to the receiver 105 may depend on any one of a number of factors such as the distance between the transmitter 101 and receiver 105, the geometry of the structure (e.g., room, building) in which the transmitter and receiver are housed, the transmission frequency, etc. In some embodiments, the channel characterization value 118 may comprise a calculation of the gain and phase associated with the channel 104, calculated as follows. The preamble 112 may include a known sequence of bits. By comparing these bits as received and decoded by the decoder 106 to the known sequence, the transmitter 105 can compute the gain and phase of the channel.

Referring still to FIG. 2, once the channel characterization value 118 is obtained, that value may be used in the decode process 120. The decode process preferably is performed by the decoder 106. The decode process 120 receives the encoded data from the payload 116 and decodes the payload using the channel characterization value 118 to produce the user data. By way of an example, the decode process 120 may implement Viterbi decoding. In Viterbi decoding, reliability metrics are computed and used in the decoding process. An example of Viterbi decoding may be found in U.S. Pat. No. 6,507,927, incorporated herein by reference. If the channel characterization value 118 represents channel gain, the value 118 may be used to scale the Viterbi reliability metric values. In some embodiments, the reliability metrics are multiplied by the channel gain is used to compute the reliability metric used in the Viterbi decoding. The scaled reliability metrics are then used in the Viterbi decoding process in the decoder 106.

FIG. 3 shows a method 130 in accordance with a preferred embodiment of the invention. The method 130 may include blocks 132-140. In 132, at least a portion of a data packet is decoded with a first channel characterization value. In block 134, at least a portion of the data packet is decoded with a second channel characterization value. The two portions may be the same or different. Each portion may be a predetermined amount of the packet from one bit to the entire packet, but preferably is less than the entire packet (e.g., the first 100 bits). Various embodiments exist for the first and second channel characterization values, some of which are described below. In 136, a determination is made as to which decoding performed best-the decoding using the first channel characterization value (block 132) or the decoding using the second channel characterization value (block 134). If Viterbi decoding is used in blocks 132 and 134, then the decision in block 136 may be made by examining the accumulated reliability metric such as which represents the accumulated reliability metrics as the decoding process works its way through the Viterbi trellis as would be understood by one of ordinary skill in the art.

If decoding using the first channel characterization value performed better, then in 138, the remaining portion of the packet is decoded preferably using the first channel characterization value. Similarly, if decoding using the second channel characterization value performed better, then in 140, the remaining portion of the packet preferably is decoded using the second channel characterization value.

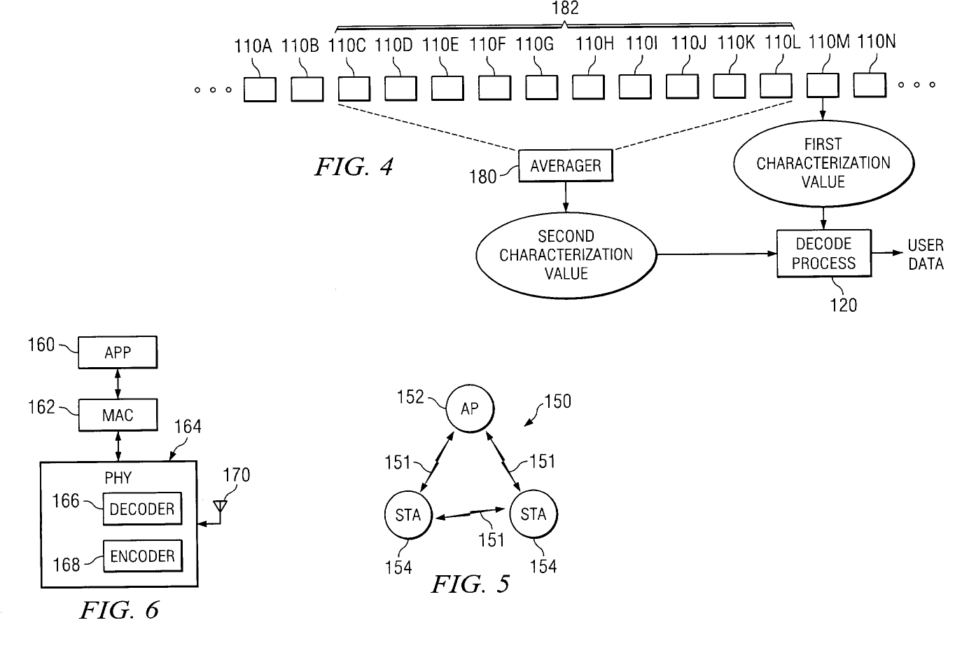

Referring to FIG. 4, a series of packets 110A-110N is shown being transmitted from the transmitter 102 to the receiver 105. The packets are shown in the order in which they are received by receiver 105. Thus, packet B follows packet A, packet C follows packet B, and so on. In the example of FIG. 4, each packet 110A-110N may be decoded according to the preferred embodiments of the invention. An embodiment of the decoding process will be described with respect to decoding packet 110M. In at least some embodiments, the first channel characterization value preferably is the characterization value obtained from the current packet being decoded (i.e., packet 110M). The second channel characterization value preferably is computed as the average of a plurality of channel characterization values associated with a plurality of preceding packets. The number of preceding packets that are included in the average may be any suitable number and may be fixed or programmable. In the example of FIG. 4, an averager 180 (which may be part of the decoder 106 or other logic in the receiver 105) computes the average of the channel characterization values associated with the 10 packets (although that number may be altered as noted above) that precede the current packet 110M. The 10 previous packets include packets 110C-110L.

In some embodiments, the averager 180 may weight the preceding channel characterization values equally. In other embodiments, the averager 180 may weight at least one preceding channel characterization value differently than at least one other channel characterization value. For example, the most recently determined channel characterzation value may be weighted greater than the older channel characterization values.

Once the channel characterization values associated with a specified number of preceding packets are averaged, the current packet (packet 110M in the example of FIG. 4) may be decoded as described previously. The process then repeats itself to decode the next packet, packet 110N. The average channel characterization value computed for decoding packet 110N includes the average of the channel characterization values associated with packets 110D-110M. The channel characterization value associated with packet 110M (immediate previously decoded packet) may comprise whichever of the first or second channel characterization values that resulted in better performance when decoding packet 110M. Similarly, the channel characterization value associated with all of the preceding packets used to compute an average may include whichever of the first or second channel characterization values that resulted in better performance when decoding each such packet.

FIG. 5 shows an exemplary embodiment of a communication system embodying the techniques described above. As shown, the communication system may be provided as a wireless network 150 comprising a plurality of wireless communication devices. Such devices may include at least one access point 152 and at least one wireless station 154 operatively in communication with one another via a wireless medium 151. The access point 152 and wireless stations 154 may communicate wirelessly with each other in accordance any one of a plurality of standards. An example of such a standard is the IEEE 802.11 family of wireless standards including, without limitation, the IEEE 802.11a wireless standard.

FIG. 6 shows a block diagram of either or both of the access point 152 and wireless stations 154. As shown, the access point or wireless station may include an application layer 160, a media access control (“MAC”) layer 162, and a physical (“PHY) layer 164. One or more applications run in the application layer 160. Such applications may include, without limitation, an electronic mail application, browser application, etc. The applications may run on a processor (not specifically shown) included within the wireless station or access point. The MAC layer 162 may provide a variety of functions and services to facilitate effective wireless communications between stations/access points. Examples of such services include data frame transmission and reception, security, and others. The PHY layer 164 provides an interface between the MAC layer 162 and the wireless channel 104 and, as such, couples to one or more antennas 170.

The PHY layer 164 in the embodiment of FIG. 6 may include a decoder 166 and an encoder 168 to permit two-way communication with another wireless station or access point 152, 154. The decoder 166 preferably functions as described above with regard to decoder 106. As such, some or all of the functionality described herein may be implemented in the PHY layer 164 of a wireless communication device 152, 154.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method usable in a communication system including at least two communication devices in communication with each other via a channel, comprising:
receiving a current packet comprising a preamble and a data payload;
obtaining a first channel characterization value using said preamble, said channel characterization value being indicative of the channel;
obtaining a second channel characterization value using a previously received packet, said second channel characterization value also being indicative of the channel; and
decoding said current packet using both of said first and second channel characterization values.

2. The method of claim 1 wherein decoding includes decoding a portion of the current packet using the first channel characterization value and also decoding a portion of the current packet using the second channel characterization value, the method also including determining a performance associated with the decoding and determining which of the first or second channel characterization values results in better performance.

3. The method of claim 2 further including decoding a remainder of the current packet using the first or second channel characterization value that was determined to result in better performance.

4. The method of claim 1 wherein obtaining the second channel characterization value comprises computing an average of a plurality of channel characterization values associated with a plurality of previously received packets.

5. The method of claim 4 wherein the plurality of previously received packets is 10.

6. The method of claim 4 wherein the computed average comprises a weighted average.

7. The method of claim 6 wherein said average weights the channel characterization value associated with a more recently received packet greater than a less recently received packet.

8. A communication system, comprising:
a transmitter that encodes information; and
a receiver that receives encoded information from the transmitter via a communication channel and decodes said encoded information, wherein said receiver:
determines a first value indicative of the communication channel from information received from the transmitter that is yet to be decoded;
determines a second value indicative of the communication channel from previously received and decoded information; and
decodes the information yet to be decoded using whichever of the first or second values that results in better decoding performance.

9. The communication system of claim 8 wherein the information received from the transmitter includes a data packet comprising a preamble and encoded data and the first value is determined using the preamble.

10. The communication system of claim 9 wherein the determination of the first value includes determining a gain associated with the communication channel.

11. The communication system of claim 9 wherein decoding includes Viterbi decoding and the gain is used to compute the reliability metric used in the Viterbi decoding.

12. The communication system of claim 8 wherein the second value comprises an average of a plurality of values indicative of the communication channel that are associated with previously decoded information.

13. The communication system of claim 12 wherein the average is a weighted average.

14. The communication system of claim 12 wherein the receiver decodes a portion of the information using the first value, decodes a portion of the information using the second value, determines which of the first or second values performs better and decodes the remainder of the information using the better performing value.

15. The communication system of claim 8 wherein the receiver decodes a portion of the information using the first value, decodes a portion of the information using the second value, determines which of the first or second values performs better and decodes the remainder of the information using the better performing value.

16. The communication system claim 8 wherein the transmitter and receiver wirelessly communicate with each other.

17. A wireless device that is adapted to wirelessly receive packets from another wireless device via a communication channel, comprising:
an antenna; and
a decoder coupled to said antenna, said decoder:
receives encoded information;
determines a first value indicative of the communication channel from said received encoded information;
determines a second value indicative of the communication channel from previously received and decoded information; and
decodes the received encoded information using whichever of the first or second values that results in better decoding performance.

18. The wireless device of claim 17 wherein the received encoded information includes a data packet comprising a preamble and encoded data and the first value is determined using the preamble.

19. The wireless device of claim 18 wherein the determination of the first value includes determining a gain associated with the communication channel.

20. The wireless device of claim 18 wherein decoding includes Viterbi decoding and the gain is used to compute a reliability metric used in the Viterbi decoding.

21. The wireless device of claim 17 wherein the second value comprises an average of a plurality of values indicative of the communication channel that are associated with previously decoded information.

22. The wireless device of claim 21 wherein the average is a weighted average.

23. The wireless device of claim 21 wherein the decoder decodes a portion of the information using the first value, decodes a portion of the information using the second value, determines which of the first or second values performs better and decodes the remainder of the information using the better performing value.

24. The communication system of claim 17 wherein the receiver decodes a portion of the information using the first value, decodes a portion of the information using the second value, determines which of the first or second values performs better and decodes the remainder of the information using the better performing value.

25. A wireless device that is adapted to wirelessly receive packets from another wireless device via a communication channel, comprising:
an antenna; and
a means for receiving encoded information, determining a first value indicative of the communication channel from said received encoded information, determining a second value indicative of the communication channel from previously received and decoded information, and decoding the received encoded information using whichever of the first or second values that results in better decoding performance.

26. The wireless device of claim 25 wherein the received encoded information includes a data packet comprising a preamble and encoded data and the first value is determined using the preamble.

27. The communication system of claim 25 wherein said means includes a means for decoding a portion of the information using the first value, decoding a portion of the information using the second value, determining which of the first or second values performs better and decoding the remainder of the information using the better performing value.
